(19) United States
(12) Patent Application Publication
(10) Pub. No.: US 2020/0410586 A1
(43) Pub. Date: Dec. 31, 2020

(54) Adjusting Method and Adjusting Device, Server and Storage Medium for Scorecard Model

(71) Applicant: SIMPLECREDIT MICRO-LENDING CO., LTD., Chongqing (CN)

(72) Inventors: Jiannuo Lin, Chongqing (CN); Zhuo Zhang, Chongqing (CN)

(21) Appl. No.: 16/977,942

(22) PCT Filed: May 31, 2018
(86) PCT No.: PCT/CN2018/089315

§ 371 Date: Sep. 3, 2020

(51) Int. Cl. G06Q 40/02; G06F 17/18

(52) U.S. Cl. CPC G06Q 40/025; G06F 17/18

(57) ABSTRACT

The invention discloses an adjusting method and an adjusting device, server and storage medium for a scorecard model, comprising: determining at least one high cardinality variable from multiple candidate independent variables of the scorecard model; determining a rolling variable from the at least one high cardinality variable according to a preset rule, wherein the rolling variable is divided into at least one group; acquiring parameter information of various groups in the at least one group in a preset time and determining WOE values corresponding to the various groups according to the parameter information; and adjusting the scorecard model according to the WOE values corresponding to the various groups and the rolling variable. The rolling variable can be selected into the scorecard model, and the scorecard model can be adjusted by utilizing the rolling variable, so that the accuracy of risk prediction results of the scorecard model is advantageously improved.

### FIELD OF THE INVENTION

The present invention relates to the technical field of computers, in particular to an adjusting method and an adjusting device, server and storage medium for a scorecard model.

### BACKGROUND OF THE INVENTION

At present, after traditional scorecard models are established, various dimensions (namely variables), coefficients of the dimensions and encoded values of weight of evidence (WOE) corresponding to the dimensions are fixed, and the models cannot be adjusted later. However, for some rolling variables with high cardinality and frequent changes in data of various groups of the variables, it is difficult to select such rolling variables into the models through information value (IV) indexes in the screening stage of the traditional scorecard models, so that the accuracy of risk prediction results of the scorecard models is seriously affected.

### SUMMARY OF INVENTION

The present invention provides an adjusting method and an adjusting device, server and storage medium for a scorecard model, a rolling variable can be selected into the scorecard model, and the scorecard model can be adjusted by utilizing the rolling variable, so that the accuracy of risk prediction results of the scorecard model is advantageously improved.

In the first aspect, the present invention provides an adjusting method for a scorecard model, comprising:

determining at least one high cardinality variable from multiple candidate independent variables of the scorecard model;

determining a rolling variable from the at least one high cardinality variable according to a preset rule;

acquiring parameter information of various groups of the rolling variable in a preset time and determining weight of evidence (WOE) values corresponding to the various groups according to the parameter information; and

adjusting the scorecard model according to the WOE values corresponding to the various groups of the rolling variable and the rolling variable.

In an embodiment, the specific mode of determining at least one high cardinality variable from multiple candidate independent variables of the scorecard model is:

calculating information values (IVs) corresponding to various candidate independent variables in the multiple candidate independent variables of the scorecard model, and outputting the IVs corresponding to the various candidate independent variables;

acquiring instruction information input by a user according to the IVs corresponding to the various candidate independent variables for determining the high cardinality variables;

and

determining at least one high cardinality variable from the multiple candidate independent variables according to the instruction information.

In an embodiment, the specific mode of determining at least one high cardinality variable from multiple candidate independent variables of a scorecard model is:

calculating the IVs corresponding to various candidate independent variables in the multiple candidate independent variables of the scorecard model, and determining the variables whose IVs are greater than a preset IV threshold as target variables, wherein each target variable is divided into at least one group;

acquiring the WOE values corresponding to various groups of each target variable; and

determining the target variables as the high cardinality variables if the number of first differences greater than a preset WOE difference threshold meets a preset high cardinality condition, wherein each first difference is a difference between the WOE values corresponding to any two groups.

In an embodiment, each high cardinality variable is divided into at least one group, and the specific mode of determining a rolling variable from the at least one high cardinality variable according to the preset rule is:

acquiring data change information of various groups of each high cardinality variable in the at least one high cardinality variable in a period; and determining the corresponding high cardinality variable as the rolling variable if the data change information of the various groups meets preset data change conditions.

In an embodiment, the scorecard model is established based on a linear regression model, and the linear regression model is composed of at least one variable and weight coefficients corresponding to various variables in the at least one variable. The specific mode of adjusting the scorecard model according to the WOE values corresponding to the various groups and the rolling variable is:

adding the rolling variable into the linear regression model corresponding to the scorecard model; and

determining the value of the rolling variable according to the WOE values corresponding to the various groups of the rolling variable.

In an embodiment, the specific mode of acquiring data change information of various groups of each high cardinality variable in the at least one high cardinality variable in a period is:

carrying out statistics on values and/or bad debt rates of various groups of each high cardinality variable in the at least one high cardinality variable in the period;

determining value change information and/or bad debt rate change information of various groups of each high cardinality variable in the period according to statistical results; and

generating data change information of various groups of each high cardinality variable in the period based on the value change information and/or the bad debt rate change information.

In an embodiment, the data change information comprises at least one of the following information: the value change information of various groups of each high cardinality variable and the bad debt rate change information of various groups of each high cardinality variable, and if a value change rate indicated by the value change information of the various groups is greater than or equal to a preset value change rate threshold or a bad debt change rate indicated by the bad debt rate change information of the various groups is greater than or equal to a preset bad debt change rate threshold, it is determined that the data change information of the various groups meets preset data change conditions.

In a second aspect, the present invention provides an adjusting device for a scorecard model, comprising:

a determining module, used for determining at least one high cardinality variable from multiple candidate independent variables of a scorecard model;

wherein the determining module is further used for determining a rolling variable from the at least one high cardinality variable according to a preset rule, and the rolling variable is divided into at least one group;

an acquiring module, used for acquiring parameter information of various groups of the rolling variable in a preset time;

wherein the determining module is further used for determining weight of evidence (WOE) values corresponding to the various groups according to the parameter information acquired by the acquiring module; and

an adjusting module, used for adjusting the scorecard model according to the WOE values corresponding to the various groups of the rolling variable and the rolling variable.

In a third aspect, the present invention provides a server which comprises a processor and a storage device, and the processor and the storage device are connected to each other, wherein the storage device is used for storing a computer program, the computer program includes program instructions, and the processor is configured to call the program instructions to execute the method in the first aspect described above.

In a fourth aspect, the present invention provides a computer readable storage medium which stores a computer program, the computer program includes program instructions, and a processor is enabled to execute the method in the first aspect described above when the program instructions are executed by the processor.

In an embodiments of the present invention, the server determines the at least one high cardinality variable from the multiple candidate independent variables of the scorecard model, determines the rolling variable from the at least one high cardinality variable according to the preset rule, acquires the parameter information of various groups of the rolling variable in the preset time, determines the weight of evidence (WOE) values corresponding to the various groups according to the parameter information, and then adjusts the scorecard model according to the WOE values corresponding to the various groups and the rolling variable. By adopting the present invention, the rolling variable can be selected into the model, and the scorecard model can be adjusted by utilizing the rolling variable, therefore the accuracy of score results of the scorecard model is improved.

### BRIEF DESCRIPTION OF THE DRAWINGS

In order to explain the embodiments of the present invention or the technical solutions in the prior art more clearly, the accompanying drawings required to be used in the embodiments will be briefly introduced below. Apparently, the accompanying drawings in the following description are only some embodiments of the present invention, and those of ordinary skill in the art can obtain other accompanying drawings based on these accompanying drawings without creative efforts.

FIG. 1 is a flowchart of an adjusting method for a scorecard model provided by an embodiment of the present invention;

FIG. 2 is a flowchart of another adjusting method for a scorecard model provided by an embodiment of the present invention;

FIG. 3 is a schematic block diagram of an adjusting device for a scorecard model provided by an embodiment of the present invention; and

FIG. 4 is a schematic block diagram of a server provided by an embodiment of the present invention.

### DETAILED DESCRIPTION OF ILLUSTRATED EMBODIMENTS

The technical solutions in the embodiments of the present invention will be described clearly and completely in conjunction with the accompany drawings in the embodiments of the present invention below. Apparently, the described embodiments are only a part of the embodiments of the present invention, but not all the embodiments. Based on the embodiments of the present invention, all other embodiments obtained by those of ordinary skill in the art without creative efforts fall within the protection scope of the present invention.

A scorecard model is used as a prediction method which can be applied to different application scenarios in combination with different business data. Exemplarily, when a scorecard model is a credit scorecard model, the credit scorecard model can describe factors affecting the individual credit level based on the analysis of a large number of credit records of credit cardholders in the past, thereby helping lending institutions to issue consumer credit. The establishment of the credit scorecard model is mainly focused on adopting applicant characteristic variables to predict the default probability of applicants, which requires that the characteristic variables entering the credit scorecard model have high predictive ability.

In an embodiments of the present invention, an information value (IV) can be adopted to measure the predictive ability of each variable, wherein the correspondence between the IV and the predictive ability can be as shown in Table 1-1.

TABLE 1-1

| IV | Predictive ability |
|---|---|
| <0.03 | None |
| 0.03-0.1 | Low |
| 0.1-0.2 | Medium |
| 0.2-0.3 | High |
| >0.3 | Extremely high |

In an embodiment, the scorecard model can be established based on a linear regression model, wherein the linear regression model is equivalent to a relationship established between a dependent variable (y) and one or more independent variables (x) and is expressed as:

y=a+β₁x₁+β₂x₂+β₃x₃+ . . . +βₙxₙ

wherein, a represents the intercept, xₙ (n is a positive integer) is an independent variable selected into the model, namely an in-model index, and βₙ is a coefficient corresponding to each independent variable.

For the traditional scorecard models, after the models are established, each independent variable xₙ, the coefficient βₙ corresponding to each independent variable, and a WOE encoded value corresponding to each independent variable are fixed, and the models cannot be adjusted later. However, for some rolling variables with high cardinality and frequent changes in data of various groups of the variables, it is difficult to select such rolling variables into the models through information value (IV) indexes during the model screening stage, but due to the characteristic of frequent change, such rolling variables are often the key variables affecting the risk prediction results. Therefore, the risk prediction results of traditional scorecard models are usually not accurate enough.

In the present invention, by determining at least one high cardinality variable from multiple candidate independent variables of a scorecard model, determining a rolling variable xₙ₊₁ from the at least one high cardinality variable according to a preset rule, acquiring parameter information of various groups of the rolling variable in a preset time, determining weight of evidence (WOE) values corresponding to the various groups according to the parameter information, then selecting the rolling variable xₙ₊₁ into the scorecard model, and determining a coefficient βₙ₊₁ corresponding to the rolling variable according to the WOE values corresponding to the various groups of the rolling variable, the accuracy of the risk prediction results of the scorecard model can be improved. Exemplarily, for a credit scorecard model, improving of the accuracy of the risk prediction results can assist lending institutions in issuing consumer credit, and thereby effectively controlling the repayment overdue situation of borrowers.

Wherein, the high cardinality variable described in the embodiment of the present invention can be a variable to which multiple groups belong. For example, the variable is a province, and multiple groups belong to the province, such as: Sichuan Province, Guangxi Province, Jiangsu Province, Guangdong Province, Hainan Province and Liaoning Province. In this case, the province variable can be determined as the high cardinality variable. The described rolling variable can be a high cardinality variable with values and/or bad debt rates changing frequently of various groups.

In an embodiment, each candidate independent variable can be divided into m groups (m is an integer greater than 0), and the IV corresponding to the candidate independent variable satisfies the following formula 1.1:

IV=Σᵢ^{m}IVᵢ

wherein, i is a positive integer less than m and indicates the i-th group in the m groups; and IVᵢ indicates the IV corresponding to the i-th group. That is, the IV of each candidate independent variable is obtained by summing the IVs corresponding to various groups of the independent variable. In the embodiment of the present invention, the specific value of IV can be determined according to the WOE value (namely WOEᵢ) of the i-th group and can specifically adopt the following formula 1.2:

IVᵢ=((Gᵢ/G_{T})−(Bᵢ/B_{T}))*WOEᵢ

wherein, Gᵢ in the above formula represents the number of responding customers in this group, G_{T} represents the number of all responding customers in samples, Bᵢ represents the number of non-responding customers in this group, and B_{T} represents the number of all non-responding customers in the samples. It can be seen from the above formula that WOE actually represents the difference between “the proportion of responding customers in the current group to all responding customers” and “the proportion of non-responding customers in the current group to all non-responding customers”, and the calculation formula of WOEᵢ can adopt the following formula 1.3:

$$W O E = ln \frac{( {G}_{i} / {G}_{T} )}{( {B}_{i} / {B}_{T} )}$$

wherein, the above responding customers refer to individuals whose predictive variable values in the scorecard model are “yes” or “1”. For example, in a risk scorecard model, the above non-responding customers correspond to default customers, which is not specifically limited in the present invention.

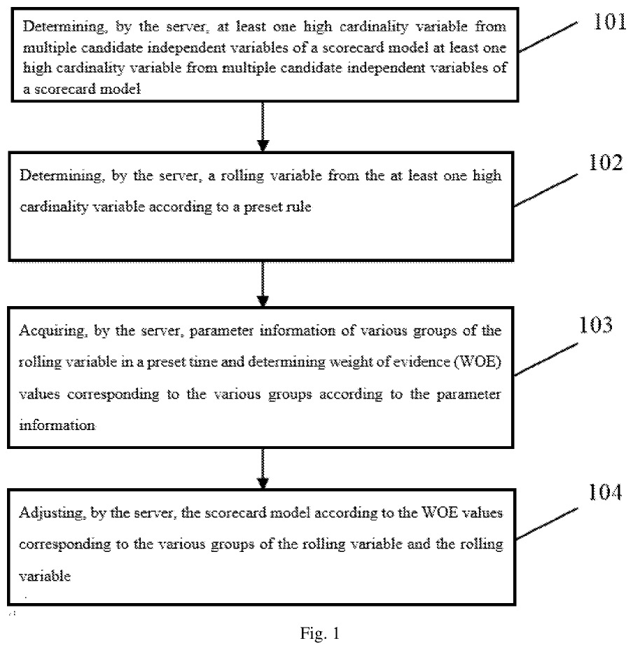

Referring to FIG. 1, FIG. 1 is a flowchart of an adjusting method for a scorecard model provided by an embodiment of the present invention. As shown in FIG. 1, the adjusting method for the scorecard model can comprise:

101, determining, by a server, at least one high cardinality variable from multiple candidate independent variables of a scorecard model.

In an embodiment, the server can calculate information values (IVs) corresponding to various candidate independent variables in the multiple candidate independent variables of the scorecard model, and output the IVs corresponding to the various candidate variables to acquire instruction information which is input by a user according to the IVs corresponding to the various variables for determining high cardinality variables, and then determine at least one high cardinality variable from the multiple candidate independent variables according to the instruction information.

Wherein, the instruction information is information generated according to user instructions and is used for instructing the server to determine at least one high cardinality variable from multiple candidate independent variables. For example, the server outputs IVs corresponding to j (j is a positive integer) candidate independent variables, that is, the server outputs j IVs (such as IV₁, IV₂, IV₃, . . . , IV₃). In this case, if a user wants to determine the candidate independent variables corresponding to IV₁ and IV₂ as high cardinality variables after viewing the j IVs, instruction information can be input for IV₁ and IV₂ for instructing the server to determine the candidate independent variables corresponding to IV₁ and IV₂ as the high cardinality variables. In this case, the server can determine the candidate independent variables corresponding to IV₁ and IV₂ as high cardinality variables after receiving the instruction information.

Exemplarily, assuming that the scorecard model includes j (j is a positive integer) candidate independent variables, the server can calculate the IV corresponding to each candidate independent variable through formulas 1.1 to 1.3, and display the calculated j IVs (such as IV₁, IV₂, IV₃, . . . , IV₃) on a display interface. After viewing the j IVs displayed on the display interface, a user can input instruction information for instructing the server to determine one or more IVs in j IVs as target IVs (such as IV₁ and IV₂). Further, after receiving the instruction information of the user, the server can determine one or more target IVs from the j IVs according to the instruction information and find the candidate independent variables corresponding to the one or more target IVs so as to determine the corresponding candidate independent variables as high cardinality variables.

In an embodiment, the server can also calculate the IVs corresponding to each candidate independent variable in the multiple candidate independent variables of the scorecard model, determine the variables whose IVs are greater than a preset IV threshold as target variables, and then acquire WOE values corresponding to various groups of each target variable, and if the number of first differences greater than a preset WOE difference threshold meets a preset high cardinality condition, the target variables are determined as the high cardinality variables. Each first difference is a difference between the WOE values corresponding to any two groups.

In an embodiment, the preset high cardinality condition is that the number of first differences greater than the preset WOE difference threshold is greater than or equal to a preset number threshold r₀ (r₀ is a positive integer), and the scorecard model includes j (j is a positive integer) candidate independent variables. In this case, the server can calculate the IV corresponding to each candidate independent variable through information algorithms represented by formulas 1.1-1.3, that is, the server obtains j IVs (such as IV₁, IV₂, IV₃, . . . , IVⱼ). Further, the j IVs can be compared with a preset IV threshold one by one to determine the IVs greater than the preset IV threshold as IV₁, then the candidate independent variable corresponding to IV₁ is determined as the target variable, wherein, the target variable comprises r₁ (r₁ is a positive integer) groups. Further, the server can calculate the WOE values corresponding to various groups of the target variable according to formula 1.3 to acquire r₁ WOE values, then further calculate the difference between every two r₁ WOE values (namely the first difference), compare all the acquired first differences with the preset WOE difference threshold, and determine the target variable as a high cardinality variable when it is determined that there are b first differences greater than the preset WOE difference threshold and b is greater than r₀.

In an embodiment, when the server determines the high cardinality variables from the multiple candidate independent variables of the scorecard model, the server can also directly adopt formula 1.3 to calculate the WOE values of various groups of any candidate independent variable in the scorecard model, compare the difference between every two WOE values, and determine the differences greater than the preset difference threshold as target differences and further determine the number of the target differences, and if the number of the target differences is greater than or equal to the number threshold, then the any candidate independent variable can be determined as the high cardinality variable.

102, determining, by the server, a rolling variable from the at least one high cardinality variable according to a preset rule.

In an embodiment, after determining the at least one high cardinality variable, the server can acquire data change information of one or more groups of any high cardinality variable in a certain period. The data change information can comprise at least one of value change information of various groups and bad debt rate change information of various groups. Further, the server can determine whether the value change information of various groups and/or the bad debt rate change information of various groups meet preset data change conditions, and if yes, the any high cardinality variable can be determined as a rolling variable.

103, acquiring, by the server, parameter information of various groups of the rolling variable in a preset time and determines weight of evidence (WOE) values corresponding to the various groups according to the parameter information.

104, adjusting, by the server, the scorecard model according to the WOE values corresponding to the various groups of the rolling variable and the rolling variable.

Wherein, the preset time is a time period which can correspond to start and end dates such as May 2018-June 2018, or can start with the current time to push back 10 days, 15 days or 1 month. The time period can be set by default in a system or can be determined according to user instructions, which is not specifically limited in the present invention.

In an embodiment, the parameter information is bad debt rate information of various groups of the rolling variable in the preset time, assuming that the rolling variable determined in step 102 is divided into r1 groups, and the preset time is the month of May 2018. In this case, the server can acquire bad debt rates of the r1 groups in the month of May 2018, determine the WOE values corresponding to the various groups according to the bad debt rates, and then adjust the scorecard model according to the rolling variable and the WOE values corresponding to the various groups.

In an embodiment, the above-mentioned scorecard model is established based on a linear regression model which is composed of at least one independent variable and weight coefficients corresponding to various independent variables in the at least one independent variable. In this case, the specific implementation mode of the server performing step 104 can be: adding a rolling variable into the linear regression model corresponding to the scorecard model, determining the value of the rolling variable according to the WOE values corresponding to various groups of the rolling variable, and then adjusting the linear regression model, that is, adjusting the scorecard model.

Exemplarily, assuming that the scorecard model is used for predicting the repayment overdue situation of borrowers in the three provinces of Guangxi, Jiangsu and Sichuan. The scorecard model is established based on a linear regression model, namely y=a+β₁x₁+β₂x₂+β₃x₃+ . . . +βₙxₙ, wherein a represents the intercept, xₙ (n is a positive integer) is an independent variable selected into the model, and βₙ is a coefficient corresponding to each independent variable. A high cardinality variable is a province variable, and the province variable is divided into the three groups of Guangxi, Jiangsu and Sichuan, the preset time is the month of May 2018, the bad debt rate information of various groups of the province variable in May 2018 is shown in Table 1-2, wherein G represents the number of bad debts, and B represents the number of non-bad debts.

TABLE 1-2

| Province | G | B | Sum | Bad debt rate |
|---|---|---|---|---|
| Guangxi | 400 | 100 | 500 | 20% |
| Jiangsu | 300 | 200 | 500 | 40% |
| Sichuan | 300 | 200 | 500 | 40% |
| Sum | 1000 | 500 | 1500 | 33% |

Further, after acquiring the bad debt rate information shown in Table 1-2, the server can determine the WOE values of the three groups of Guangxi, Jiangsu and Sichuan of the province variable according to formula 1.3 as:

$$ln \frac{( 400 / 1000 )}{( 100 / 500 )} = 0.69 ; ln \frac{( 300 / 1000 )}{( 200 / 500 )} = - 0.2 \; 87 ;$$

$$ln \frac{( 300 / 1000 )}{( 200 / 500 )} = - 0.287 ;$$

Then, the server can express the rolling variable, namely the province as xₚᵣₒᵥ and select the rolling variable into the linear regression model, that is, one rolling variable xₚᵣₒᵥ is added to the above linear regression model. The linear regression model after addition of the rolling variable is: y=a+β₁x₁+β₂x₂+λ₃x₃+ . . . +βₙ xₙ+βₙ₊₁xₚᵣₒᵥ, when the server predicts the repayment overdue situation in Guangxi Province through this model, the value of xₚᵣₒᵥ is the WOE value corresponding to Guangxi, namely 0.69; when the server predicts the repayment overdue situation in Jiangsu Province through this model, the value of xₚᵣₒᵥ is the WOE value corresponding to Jiangsu, namely −0.287; when the server predicts the repayment overdue situation in Sichuan Province through this model, the value of xₚᵣₒᵥ is the WOE value corresponding to Sichuan, namely −0.287, thus, the linear regression model is adjusted, that is, the scorecard model is adjusted, and the accuracy of the risk prediction results of the scorecard model is improved.

In the embodiment of the present invention, the server determines the at least one high cardinality variable from the multiple candidate independent variables of the scorecard model, determines the rolling variable from the at least one high cardinality variable according to a preset rule, acquires the parameter information of various groups in at least one group of the rolling variable in the preset time, determines the weight of evidence (WOE) values corresponding to various groups according to the parameter information, and then adjusts the scorecard model according to the WOE values corresponding to the various groups and the rolling variable. By adopting the present invention, the scorecard model can be adjusted by utilizing the rolling variable, therefore the accuracy of the risk prediction results of the scorecard model is improved.

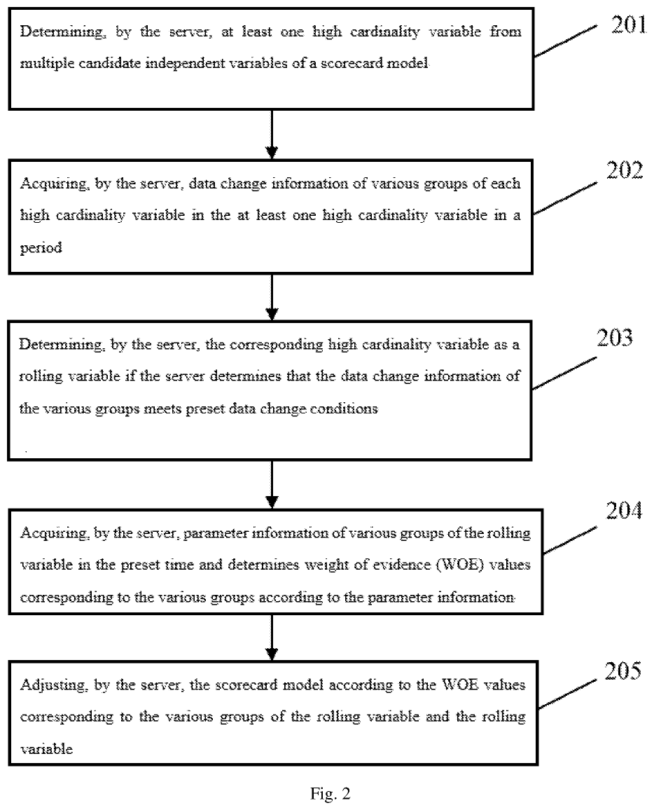

Referring to FIG. 2 then, FIG. 2 is a flowchart of another scorecard model adjusting method provided by an embodiment of the present invention. As shown in FIG. 2, the adjusting method for the scorecard model can comprise:

201, determining, by the server, at least one high cardinality variable from multiple candidate independent variables of a scorecard model.

Wherein the specific mode of step 201 can refer to the related description of step 101 in the foregoing embodiment, which is not described in detail herein.

202, acquiring, by the server, data change information of various groups of each high cardinality variable in the at least one high cardinality variable in a period.

Wherein, the period can be a time period which can correspond to start and end dates such as May 2018-June 2018, or can start with the current time to push back 10 days, 15 days or 1 month. The specific time period corresponding to the period can be set by default by a system or can be determined according to user instructions. Wherein, the data change information can be value change information and/or bad debt rate change information of various groups of each high cardinality variable.

In an embodiment, the server can carry out statistics on the values and/or the bad debt rates of various groups of each high cardinality variable in the at least one high cardinality variable in the period, determine the value change information and/or the bad debt rate change information of various groups of each high cardinality variable in the period according to statistical results, and then generate the data change information of various groups of each high cardinality variable in the period based on the value change information and/or the bad debt rate change information.

During specific implementation, the server can acquire the values and/or the bad debt rates of various groups of each high cardinality variable in the at least one high cardinality variable at a preset time interval in the period, that is, each time interval corresponds to an acquiring time node, then determine the value change information and/or the bad debt rate change information of various groups of each high cardinality variable in the period by carrying out statistics on the values and/or the bad debt rates, obtained in the period, of various groups at each time node, and generate the data change information of various groups of each high cardinality variable in the period based on the value change information and/or the bad debt rate change information.

Exemplarily, assuming that the above period is the month of April 2018, the preset time interval is 15 days, and the scorecard model is used for predicting the overdue situation of more than 60 days in any period in the month of April 2018; a certain high cardinality variable x₁ in at least one high cardinality variable is the age of borrowers, according to the characteristics of age, the high cardinality variable, namely the age can be divided into multiple groups such as 18-25, 25-40 and 40-65; and data were acquired in the month of April 2018 twice in total, first data were acquired on Apr. 15, 2018, and the acquired data are data statistical results under the groups of x₁ shown in Table 2-1; and second data were acquired on Apr. 30, 2018, and the acquired data are data statistical results under the groups of x₁ shown in Table 2-2.

TABLE 2-1
Apr. 15, 2018

| Age | Non-overdue | Overdue | Bad debt rate |
|---|---|---|---|
| 18-25 | 200 | 300 | 0.60 |
| 25-40 | 100 | 400 | 0.80 |
| 40-65 | 300 | 200 | 0.67 |
| Sum | 600 | 900 | 0.60 |

TABLE 2-2
Apr. 30, 2018

| Age | Non-overdue | Overdue | Bad debt rate |
|---|---|---|---|
| 18-25 | 300 | 200 | 0.67 |
| 25-40 | 400 | 100 | 0.2 |
| 40-65 | 200 | 300 | 0.60 |
| Sum | 900 | 600 | 0.4 |

After acquiring the data in Table 2-1 and Table 2-2, the server can determine that the bad debt change rate differences (namely the bad debt rate change information) under the three groups of 18-25, 25-40 and 40-65 in April 2018 are 0.07, 0.6 and 0.07 respectively by analyzing the data recorded in Table 2-1 and Table 2-2, similarly, overdue value change differences under the three groups of 18-25, 25-40 and 40-65 are 100, 300 and 400 respectively, and non-overdue value change differences are 100, 300, and 100 respectively, wherein, the overdue value change differences and the non-overdue value change differences under the three groups form value change information of the three groups.

203, determining, by the server, the corresponding high cardinality variable as a rolling variable if the server determines that the data change information of the various groups meets preset data change conditions.

In an embodiment, the data change information comprises at least one of the following information: value change information of various groups of each high cardinality variable and bad debt rate change information of various groups of each high cardinality variable. The aforementioned preset data change condition can be that a value change rate indicated by the value change information is greater than or equal to a preset value change rate threshold, or a bad debt change rate indicated by the bad debt rate change information is greater than or equal to a preset bad debt change rate threshold. Before performing step 203, the server can acquire the above-mentioned value change information and/or bad debt rate change information from the data change information, and determine the value change rate of various groups of each high cardinality variable according to the value change information, and determine the bad debt change rate of various groups of the high cardinality variable according to the bad debt rate change information. In an embodiment, the server can determine that the data change information of the various groups meets the preset data change conditions when the value change rate of various groups of the high cardinality variable is greater than or equal to the preset value change rate threshold. In another embodiment, the server can determine that the data change information of the various groups meets the preset data change conditions when the bad debt change rate of various groups of the high cardinality variable is greater than or equal to the preset bad debt change rate threshold. In another embodiment, the server can also determine that the data change information of the various groups meets the preset data change conditions when the value change rate of various groups of the high cardinality variable is greater than or equal to the preset value change rate threshold and the bad debt change rate of various groups of the high cardinality variable is greater than or equal to the preset bad debt change rate threshold.

204, acquiring, parameter information of various groups of the rolling variable in the preset time and determines weight of evidence (WOE) values corresponding to the various groups according to the parameter information.

205, adjusting, by the server, the scorecard model according to the WOE values corresponding to the various groups of the rolling variable and the rolling variable.

Wherein, the specific implementation modes of step 204 and step 205 can refer to the related description of step 103 and step 104 in the foregoing embodiment, which is not described in detail herein.

In the embodiment of the present invention, the server determines the at least one high cardinality variable from the multiple candidate independent variables of the scorecard model, acquires the data change information of various groups of each high cardinality variable in the at least one high cardinality variables in the period, then determines the corresponding high cardinality variable as the rolling variable if the server determines that the data change information of the various groups meets the preset data change conditions, acquires the parameter information of various groups of the rolling variable in the preset time, determines the weight of evidence (WOE) values corresponding to the various groups according to the parameter information, and then adjusts the scorecard model according to the WOE values corresponding to the various groups of the rolling variable and the rolling variable. By adopting the present invention, the scorecard model can be adjusted by utilizing the rolling variable, and therefore the accuracy of the risk prediction results of the scorecard model is improved.

An embodiment of the present invention provides an adjusting device for a scorecard model, and the device comprises modules for executing the method described in FIG. 1 or FIG. 2. Specifically, FIG. 3 is a schematic block diagram of a device according to an embodiment of the present invention. The device of the embodiment comprises: a determining module 30, an acquiring module 31 and an adjusting module 32, wherein:

the determining module 30 is used for determining at least one high cardinality variable from multiple candidate independent variables of a scorecard model;

the determining module 30 is further used for determining a rolling variable from the at least one high cardinality variable according to a preset rule;

the acquiring module 31 is used for acquiring parameter information of various groups of the rolling variable in a preset time;

the determining module 30 is further used for determining weight of evidence (WOE) values corresponding to the various groups according to the parameter information acquired by the acquiring module; and

the adjusting module 32 is used for adjusting the scorecard model according to the WOE values corresponding to the various groups of the rolling variable and the rolling variable.

In an embodiment, the determining module 30 is specifically used for:

calculating information values (IVs) corresponding to various candidate independent variables in the multiple candidate independent variables of the scorecard model, and outputting the IVs corresponding to the various candidate independent variables;

acquiring instruction information input by a user according to the IVs corresponding to the various candidate independent variables for determining the high cardinality variables;

and

determining at least one high cardinality variable from the multiple candidate independent variables according to the instruction information.

In an embodiment, the determining module 30 is specifically used for:

calculating the IVs corresponding to various candidate variables in the multiple candidate independent variables of the scorecard model, and determining the candidate independent variables whose IVs are greater than a preset IV threshold as target variables, and each target variable is divided into at least one group;

acquiring the WOE values corresponding to various groups of each target variable; and

determining the target variables as the high cardinality variables if the number of first differences greater than a preset WOE difference threshold meets a preset high cardinality condition, wherein each first difference is a difference between the WOE values corresponding to any two groups.

The determining module 30 is specifically used for: acquiring data change information of various groups of each high cardinality variable in the at least one high cardinality variable in a period; and

determining the corresponding high cardinality variable as a rolling variable if the data change information of the various groups meets preset data change conditions.

In an embodiment, the scorecard model is established based on a linear regression model, and the linear regression model is composed of at least one independent variable and weight coefficients corresponding to various independent variables in the at least one independent variable. The adjusting module 32 is specifically used for: adding the rolling variable into the linear regression model corresponding to the scorecard model; and determining the value of the rolling variable according to the WOE values corresponding to various groups of the rolling variable.

In an embodiment, the acquiring module 31 is specifically used for:

carrying out statistics on values and/or bad debt rates of various groups of each high cardinality variable in the at least one high cardinality variable in the period;

determining value change information and/or bad debt rate change information of various groups of each high cardinality variable in the period according to statistical results; and

generating data change information of various groups of each high cardinality variable in the period based on the value change information and/or the bad debt rate change information.

In an embodiment, the data change information comprises at least one of the following information: the value change information of various groups of the high cardinality variable and the bad debt rate change information of various groups of the high cardinality variable. The determining module 30 is further used for: determining that the data change information of the various groups meets the preset data change conditions if the value change rate indicated by the value change information is greater than or equal to a preset value change rate threshold or the bad debt change rate indicated by the bad debt rate change information is greater than or equal to a preset bad debt change rate threshold.

It is understandable that the functions of functional modules and units of the scorecard model adjusting device of the embodiment can be achieved specifically according to the method in the above method embodiments, and the specific implementation process can refer to the related description of the above method embodiments, which is not described in detail herein.

In the embodiment of the present invention, the determining module 30 determines the at least one high cardinality variable from the multiple candidate independent variables of the scorecard model and determines the rolling variable from the at least one high cardinality variable according to the preset rule, the acquiring module 31 acquires the parameter information of various groups of the rolling variable in a preset time, the determining module 30 determines the weight of evidence (WOE) values corresponding to the various groups according to the parameter information acquired by the acquiring module, and the adjusting module 32 adjusts the scorecard model according to the WOE values corresponding to the various groups of the rolling variable and the rolling variable. By adopting the present invention, the scorecard model can be adjusted by utilizing the rolling variable, therefore the accuracy of the risk prediction results of the scorecard model is improved.

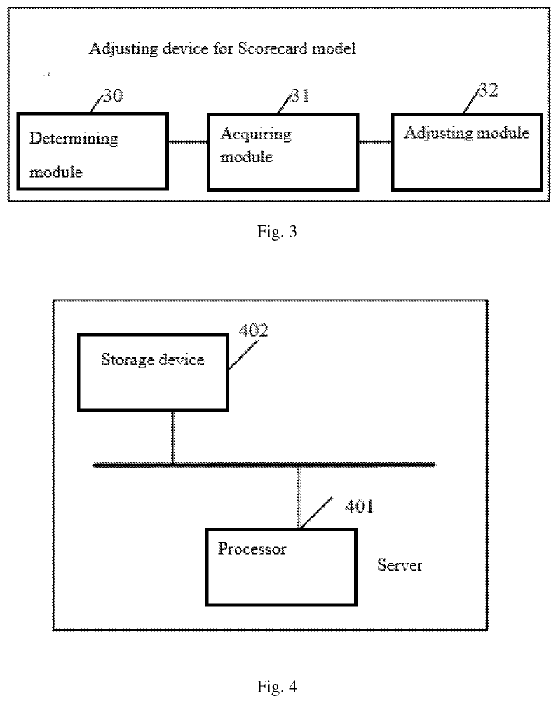

FIG. 4 is a schematic block diagram of a server provided by an embodiment of the present invention. The server shown in FIG. 4 in the embodiment can comprise: one or more processors 401 and one or more storage devices 402. The aforementioned processor 401 and storage device 402 are connected by a bus. The storage device 402 is used for storing a computer program, and the computer program includes program instructions, and the processor 401 is used for executing the program instructions stored in the storage device 402. Wherein, the processor 401 is configured to call the program instructions to:

select a first dependent variable and a second dependent variable for the scorecard model, wherein the first dependent variable and the second dependent variable belong to the same dimension;

determine at least one high cardinality variable from multiple candidate independent variables of the scorecard model;

determine a rolling variable from the at least one high cardinality variable according to a preset rule;

acquire parameter information of various groups of the rolling variable in a preset time, and determine weight of evidence (WOE) values corresponding to the various groups according to the parameter information; and

adjust the scorecard model according to the WOE values corresponding to the various groups of the rolling variable and the rolling variable.

In an embodiment, the processor 401 can be used for calculating the information values (IVs) corresponding to various candidate independent variables in the multiple candidate independent variables of the scorecard model, and outputting the IVs corresponding to the various candidate independent variables; acquiring instruction information input by a user according to the IVs corresponding to the various candidate independent variables for determining the high cardinality variables; and determining the at least one high cardinality variable from the multiple candidate independent variables according to the instruction information.

In an embodiment, the processor 401 can also be used for calculating the IVs corresponding to various candidate variables in the multiple candidate independent variables of the scorecard model, and determining the candidate independent variables whose IVs are greater than a preset IV threshold as target variables, wherein each target variable is divided into at least one group; acquiring the WOE values corresponding to various groups of each target variable; and determining the target variables as the high cardinality variables if the number of first differences greater than a preset WOE difference threshold meets a preset high cardinality condition, wherein each first difference is a difference between the WOE values corresponding to any two groups.

In an embodiment, the processor 401 can further be used for acquiring the data change information of various groups of each high cardinality variable in the at least one high cardinality variable in the period; and determining the corresponding high cardinality variable as the rolling variable if the data change information of the various groups meets preset data change conditions.

In an embodiment, the scorecard model is established based on a linear regression model, and the linear regression model is composed of at least one independent variable and weight coefficients corresponding to various independent variables in the at least one independent variable. The processor 401 can further be used for: adding the rolling variable into the linear regression model corresponding to the scorecard model; and determining the value of the rolling variable according to the WOE values corresponding to various groups of the rolling variable.

In an embodiment, the processor 401 can further be used for carrying out statistics on values and/or bad debt rates of various groups of each high cardinality variable in the at least one high cardinality variable in the period; determining value change information and/or bad debt rate change information of various groups of each high cardinality variable in the period according to statistical results; and generating data change information of various groups of each high cardinality variable in the period based on the value change information and/or the bad debt rate change information.

In an embodiment, the data change information comprises at least one of the following information: the value change information of various groups of the high cardinality variable and the bad debt rate change information of various groups of the high cardinality variable. The processor 401 can further determine that the data change information of the various groups meets preset data change conditions if value change rate indicated by the value change information is greater than or equal to a preset value change rate threshold or bad debt change rate indicated by the bad debt rate change information is greater than or equal to a preset bad debt change rate threshold.

It should be understood that in the embodiment of the present invention, the processor 401 can be a central processing unit (CPU), and the processor can also be other general-purpose processors, digital signal processors (DSP), application specific integrated circuits (ASIC), field-programmable gate arrays (FPGA) or other programmable logic devices, discrete gates or transistor logic devices, discrete hardware components and the like. The general-purpose processors can be microprocessors, or the processors can also be any conventional processors or the like.

The storage device 402 can comprise a read-only memory and a random access memory, and provide instructions and data to the processor 401. A part of the storage device 402 can also comprise a non-volatile random access memory. For example, the storage device 402 can also store device type information.

During specific implementation, the processor 401 described in the embodiment of the present invention can execute the embodiments of the scorecard model adjusting method provided in FIGS. 1 and 2 and the implementation of the scorecard model adjusting device described in FIG. 3, which is not described in detail herein.

An embodiment of the present invention further provides a computer readable storage medium, the computer readable storage medium stores a computer program, the computer program includes program instructions, and the steps executed by a server in the method embodiments described in FIG. 1 or FIG. 2 can be executed when the program instructions are executed by a processor.

Those of ordinary skill in the art can understand that only the preferred embodiments of the present invention are disclosed above, and certainly cannot limit the scope of claims of the present invention. Therefore, equivalent changes made according to the claims of the present invention still fall within the scope of the present invention.

1. An adjusting method for a scorecard model, characterized by comprising:
determining at least one high cardinality variable from multiple candidate independent variables of the scorecard model;
determining a rolling variable from the at least one high cardinality variable according to a preset rule;
acquiring parameter information of various groups of the rolling variable in a preset time and determining WOE values corresponding to the various groups according to the parameter information; and
adjusting the scorecard model according to the WOE values corresponding to the various groups of the rolling variable and the rolling variable.

2. The method according to claim 1, characterized in that the step of determining at least one high cardinality variable from multiple candidate independent variables of the scorecard model comprises:
calculating IVs corresponding to various candidate independent variables in the multiple candidate independent variables of the scorecard model, and outputting the IVs corresponding to the various candidate independent variables;
acquiring instruction information input by a user according to the IVs corresponding to the various candidate independent variables for determining the high cardinality variables; and
determining at least one high cardinality variable from the multiple candidate independent variables according to the instruction information.

3. The method according to claim 1, characterized in that the step of determining at least one high cardinality variable from multiple candidate independent variables of the scorecard model comprises:
calculating the IVs corresponding to various candidate variables in the multiple candidate independent variables of the scorecard model, and determining the candidate independent variables whose IVs are greater than a preset IV threshold as target variables, wherein each target variable is divided into at least one group;
acquiring the WOE values corresponding to various groups of the target variables; and
determining the target variables as the high cardinality variables if a number of first differences greater than a preset WOE difference threshold meets a preset high cardinality condition, wherein the first difference is a difference between the WOE values corresponding to any two groups.

4. The method according to claim 1, characterized in that the step of determining a rolling variable from the at least one high cardinality variable according to a preset rule comprises:
acquiring data change information of various groups of each high cardinality variable in the at least one high cardinality variable in a period; and
determining the corresponding high cardinality variable as the rolling variable if the data change information of the various groups meets preset data change conditions.

5. The method according to claim 1, characterized in that the scorecard model is established based on a linear regression model, and the linear regression model is composed of at least one independent variable and weight coefficients corresponding to various independent variables in the at least one independent variable, and the step of adjusting the scorecard model according to the WOE values corresponding to various groups of the rolling variable and the rolling variable comprises:
adding the rolling variable into the linear regression model corresponding to the scorecard model; and
determining the value of the rolling variable according to the WOE values corresponding to various groups of the rolling variable.

6. The method according to claim 4, characterized in that the step of acquiring data change information of various groups of each high cardinality variable in the at least one high cardinality variable in a period comprises:
carrying out statistics on values and/or bad debt rates of various groups of each high cardinality variable in the at least one high cardinality variable in the period;
determining value change information and/or bad debt rate change information of various groups of each high cardinality variable in the period according to statistical results; and
generating data change information of various groups of each high cardinality variable in the period based on the value change information and/or the bad debt rate change information.

7. The method according to claim 4, characterized in that the data change information comprises at least one of the following information: the value change information of various groups of each high cardinality variable and the bad debt rate change information of various groups of each high cardinality variable, and the method further comprises:
determining that the data change information of the various groups meets a preset data change condition if a value change rate indicated by the value change information is greater than or equal to a preset value change rate threshold or a bad debt change rate indicated by the bad debt rate change information is greater than or equal to a preset bad debt change rate threshold.

8. An adjusting device for a scorecard model, characterized by comprising:
a determining module, used for determining at least one high cardinality variable from multiple candidate independent variables of the scorecard model;
wherein the determining module is further used for determining a rolling variable from the at least one high cardinality variable according to a preset rule;
an acquiring module, used for acquiring parameter information of various groups of the rolling variable in a preset time;
wherein the determining module is further used for determining WOE values corresponding to the various groups according to the parameter information acquired by the acquiring module; and
an adjusting module, used for adjusting the scorecard model according to the WOE values corresponding to various groups of the rolling variable and the rolling variable.

9. (canceled)

10. A computer readable storage medium, characterized in that the computer readable storage medium stores a computer program, the computer program includes program instructions, and a processor is enabled to execute the method according to claim 1 when the program instructions are executed by the processor.

11. The method according to claim 2, characterized in that the step of determining a rolling variable from the at least one high cardinality variable according to a preset rule comprises:
acquiring data change information of various groups of each high cardinality variable in the at least one high cardinality variable in a period; and
determining the corresponding high cardinality variable as the rolling variable if the data change information of the various groups meets preset data change conditions.

12. The method according to claim 3, characterized in that the step of determining a rolling variable from the at least one high cardinality variable according to a preset rule comprises:
acquiring data change information of various groups of each high cardinality variable in the at least one high cardinality variable in a period; and
determining the corresponding high cardinality variable as the rolling variable if the data change information of the various groups meets preset data change conditions.

13. The method according to claim 8, characterized in that the data change information comprises at least one of the following information: the value change information of various groups of each high cardinality variable and the bad debt rate change information of various groups of each high cardinality variable, and the method further comprises:
determining that the data change information of the various groups meets a preset data change condition if a value change rate indicated by the value change information is greater than or equal to a preset value change rate threshold or a bad debt change rate indicated by the bad debt rate change information is greater than or equal to a preset bad debt change rate threshold.
